(19) United States
(12) Patent Application Publication
(10) Pub. No.: US 2010/0107808 A1
(43) Pub. Date: May 6, 2010

(54) Method for increasing torsional fatigue strength in crankshafts

(75) Inventors: Ross W. Alderton, Darlington (GB); John J. Purcell, (US); Stepehn J. Saxby, Beijing (CN)

Correspondence Address: Studebaker & Brackett PC, One Fountain Square, 11911 Freedom Drive, Suite 750, Reston, VA, 20190, US

(73) Assignee: Cummins Inc., Columbus, IN (US)

(21) Appl. No.: 12/221,362

(22) Filed: Aug. 1, 2008

(51) Int. Cl. F16C 3/14; B23P 17/00; F16C 3/06

(52) U.S. Cl. 74/605; 29/888.08

(57) ABSTRACT

A method for processing a cast iron crankshaft to improve the torsional fatigue strength of the crankshaft includes forming oil holes into a portion of the crankshaft, treating the portion of the crankshaft to harden an annular area of the portion, and roller burnishing a length of the interior of the oil holes to an increased diameter. The roller burnished length of the oil holes extending from a surface of the crankshaft to at least beyond the hardened annular area.

### FIELD OF THE INVENTION

The present invention generally relates to processes for increasing fatigue strength in materials for use on engines, and more particularly to processes for increasing the torsional fatigue strength of cast iron materials to permit use of such materials in the production of engine crankshafts.

### BACKGROUND OF THE INVENTION

Modern engines, such as diesel engines for vehicles, produce significant power through fuel combustion, which causes reciprocal motion of pistons, which in turn cause rotation of a crankshaft. The rotating crankshaft is coupled to various systems on the vehicle, including the transmission, to cause rotation of wheels and motion of the vehicle.

The stresses on the crankshaft are severe, and increase with engine output power. One of the stresses imparted to the crankshaft is torsional stress, which is a type of shear stress resulting from the forces urging the crankshaft to twist substantially along its longitudinal axis during operation. It is known that one of the areas of the crankshaft most susceptible to failure as a result of torsional stress is the area of the crankshaft oil holes. Oil holes are generally formed at various locations along the length of the crankshaft to distribute oil or other lubricant onto bearing surfaces, thereby decreasing friction. The absence of material at the oil holes may make these areas of the crankshaft especially weak, particularly after an extended period of use. In other words, the torsional fatigue strength of the crankshaft in the vicinity of the oil holes may limit the power output of the crankshaft.

One approach to providing crankshafts with high torsional fatigue strength is to manufacture the crankshafts from high strength steel. Steel, however, is relatively expensive.

As such, the cost of the engine is increased as a result of its use. Another approach is through use of inductive hardening as explained in U.S. Pat. No. 3,623,128.

### SUMMARY OF THE INVENTION

In one embodiment of the present disclosure, the torsional fatigue strength of a cast iron crankshaft is increased through roller burnishing the interior of the oil holes formed in the crankshaft from the openings of the holes to at least past the transition of a hardened area of the cast iron material through which the holes extend.

### BRIEF DESCRIPTION OF THE DRAWINGS

The above-mentioned and other features of this invention and the manner of obtaining them will become more apparent and the invention itself will be better understood by reference to the following description of embodiments of the present invention taken in conjunction with the accompanying drawings, wherein:

FIG. 1 is a partially fragmented side view of a crankshaft.

FIG. 2 is a fragmented, cross-sectional view of a portion of a crankshaft, depicting an oil hole processed according to one embodiment of the present disclosure.

Although the drawings represent embodiments of various features and components according to the present invention, the drawings are not necessarily to scale and certain features may be exaggerated in order to better illustrate and explain the present invention. The exemplification set out herein illustrates embodiments of the invention, and such exemplifications are not to be construed as limiting the scope of the invention in any manner.

### DETAILED DESCRIPTION OF EMBODIMENTS OF THE INVENTION

For the purposes of promoting an understanding of the principles of the invention, reference will now be made to the embodiments illustrated in the drawings, which are described below. It will nevertheless be understood that no limitation of the scope of the invention is thereby intended. The invention includes any alterations and further modifications in the illustrated device and described method and further applications of the principles of the invention, which would normally occur to one skilled in the art to which the invention relates. Moreover, the embodiments were selected for description to enable one of ordinary skill in the art to practice the invention.

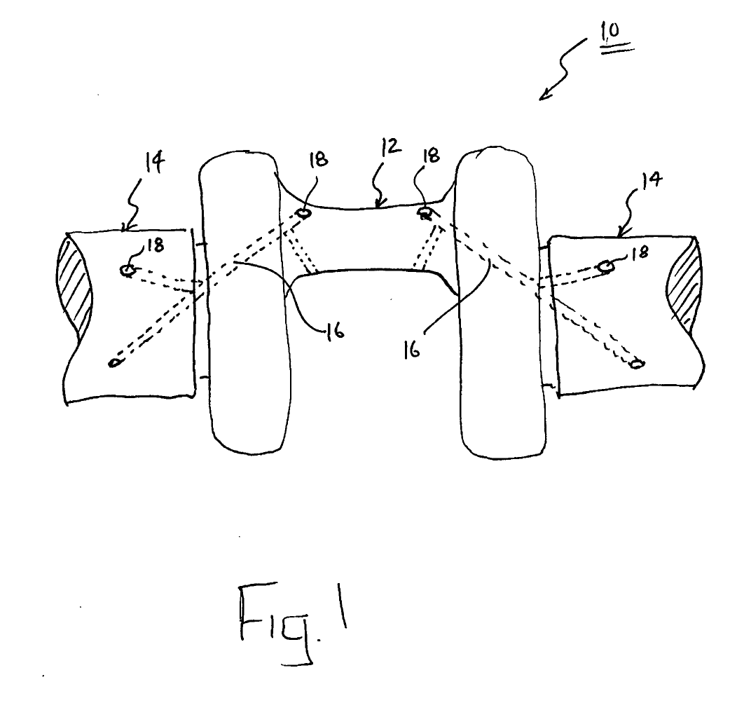

Referring now to FIG. 1, a portion of a crankshaft 10 is depicted as including a crank pin bearing 12 and a pair of main bearings 14. As is well understood by those skilled in the art, crank pin bearing 12 is coupled to a connecting rod (not shown) at the opposite end of a piston (not shown). Main bearings 14 are supported for rotation by bearings (not shown) held by the engine block (not shown). Crankshaft 10 is formed of ductile cast iron material such as any of the nodular irons according to German Standard DIN 1693. Crankshaft 10 also includes a plurality of oil holes 16 which extend through portions of crankshaft 10 to distribute oil or other lubricant to the bearing surfaces. As shown, oil holes 16 may be drilled at an angle relative to the longitudinal axis of crankshaft 10, and may branch off to a plurality of openings 18 at the bearing surfaces. While oil holes 16 are depicted as being formed at angles other than 90 degrees relative to the crankshaft longitudinal axis, it should be understood that oil holes 16 may be formed at any angle relative to the longitudinal axis.

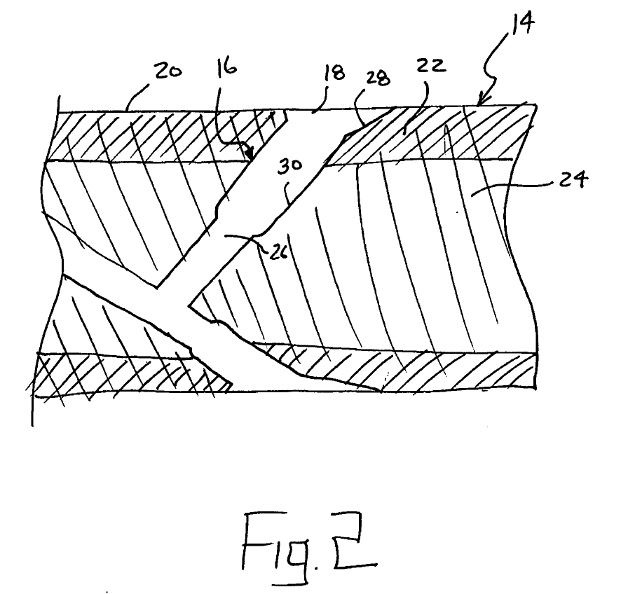

FIG. 2 depicts a portion of a main bearing 14 with an oil hole 16 extending from the bearing surface 20 (i.e., the exterior surface) into the main bearing 14. It should be understood that oil holes 16 extending into crank pin bearings 12, while not described herein, may similarly be processed according to the principles of the present disclosure. Main bearing 14 includes a hardened portion 22 and an interior portion 24. Any of a variety of different known processes may be used to harden the cast iron material in hardened portion 22.

Oil hole 16 includes an opening 18 and an interior bore 26 formed in a conventional manner using a drill or other suitable tool. Adjacent opening 18, oil hole 16 includes a chamfered portion 28 formed in a conventional manner. Oil hole 16 further includes a burnished portion 30 which is formed by roller burnishing. As is known in the art, the specific requirements (e.g., speed, pressure, etc.) for roller burnishing vary from burnishing tool to burnishing tool, and depend upon the material being burnished. Burnished portion 30 extends from chamfered portion 28 to interior portion 24 of main bearing 14 and terminates at a terminating end which is shown in the depicted embodiment in flow communication with another oil hole extending from another bearing of the crankshaft. As should be apparent from the foregoing, burnished portion 30 extends, at a minimum, beyond the transition of hardened portion 22 and interior portion 24. Burnished portion 30 may, in another embodiment of the present disclosure, extend the entire length of interior bore 26. As shown, burnished portion 30 has a diameter that is somewhat larger (e.g., 2%) than the diameter of the portion of interior bore 26 that has not been burnished.

The process of burnishing burnished portion 30 improves the surface finish of oil hole 16. An improved surface finish at burnished portion 30 may impact the life of crankshaft 10 as it undergoes cyclical loading in service. A surface with fewer flaws provides fewer locations from which cracks are likely to originate. As such, a reduction of surface defects may increase the service life of crankshaft 10.

In many situations, surface finish has a relatively minor influence on fatigue strength. The production of residual compressive stresses in burnished portion 30 of main bearing 14 is primarily responsible for the increased torsional fatigue strength. Residual compressive stresses reduce the effects of tension during cyclic loading. Nearly all formed surfaces are in some state of residual stress (compression or tension). Surfaces in high tension often crack and fail quicker than if there were no stresses at all, as a result of the higher tension produced during a loading cycle. This tension pulls at the surface of the material and weakens it. Oscillating tension eventually causes damage at some small point on the surface, usually a defect or a stress concentration location such as a corner. Cracks leading to failure generally originate at (and grow from) such surface locations. It follows that a surface in compression experiences less tension during loading. As such, cracks are less likely to form at the surface and the component lasts longer and/or can withstand greater forces.

In one embodiment of the present disclosure, a roller burnishing tool is used to create burnished portion 30. Such tools generally include steel or carbide rollers that rotate at high speeds while being placed in contact with the surface (such as interior bore 26) with a slight interference. The resulting plastic deformation of interior bore 26 leaves residual compressive stresses at burnished portion 30 in addition to smoothing the surface finish. In another embodiment, multiple passes are performed to cold-work the surface, which may increase the material's tensile strength. Appendix 1 shows data for rolled and non-rolled oil holes, and a comparison of the resulting fatigue strength.

One method for processing cast iron to form a crankshaft according to the principles of the present disclosure is as follows: First, the crankshaft is cast and prepared for oil hole drilling in a conventional manner. The oil holes are then drilled into the crankshaft at the desired locations. The openings of the oil holes may be chamfered. The crank pin bearings 12 and main bearings 14 are then treated using any of a variety of conventional hardening techniques to achieve the desired hardness. After hardening, the oil holes are roller burnished to a diameter that is fractionally larger than the drilled diameter of the oil holes. The roller burnishing is performed into the oil holes beyond the transition of the hardened portion of the bearings 12, 14 to the interior portion. Although roller burnishing is described herein, it should be understood that other mechanical and non-mechanical techniques for inducing compressive stress in a non-through hole that must remain open to oil flow may be employed. For example, and without limitation, autofrettage may be used to induce residual stress by subjecting interior portion 30 to very high pressure fluid.

While this invention has been described as having exemplary designs, the present invention may be further modified within the spirit and scope of this disclosure. For example, although steel crankshafts are stronger than cast iron crankshafts, the process of the present disclosure may nonetheless be used to increase the torsional fatigue strength of steel crankshafts as well. Indeed, the present process may be used with any of a variety of different types of metal. This application is therefore intended to cover any variations, uses, or adaptations of the invention using its general principles. Further, this application is intended to cover such departures from the present disclosure as come within known or customary practice in the art to which this invention pertains.

what is claimed is:

1. A method for processing a crankshaft to improve the torsional fatigue strength of the crankshaft, including the steps of:
forming an oil hole having an interior bore that extends into a portion of the crankshaft, the interior bore having a first diameter;
treating the portion of the crankshaft to harden an annular area of the portion;
roller burnishing a length of the interior bore of the oil hole to a diameter that is larger than the first diameter, the length extending from a surface of the portion of the crankshaft to beyond the annular area.

2. The method of claim 1, further including the step of chamfering an opening of the oil hole.

3. The method of claim 2, wherein the forming step includes drilling into the portion of the crankshaft at an acute angle relative to a longitudinal axis of the crankshaft to form the oil hole.

4. A crankshaft, including:
a main bearing having an exterior surface; and
a crank pin bearing having an exterior surface;
wherein at least one of the main bearing and the crank pin bearing including an oil hole having a single opening at the exterior surface of the at least one bearing and extending into the at least one bearing from the exterior surface to an inner location of the at least one bearing which is beyond a hardened area of the at least one bearing, the oil hole having an interior bore with a first portion with a first diameter extending substantially from the exterior surface to an intermediate location beyond the hardened annular area and a second portion with a second diameter extending from the intermediate location to the inner location, the first diameter being larger than the second diameter as a result of induced compressive stress.

5. The crankshaft of claim 4, wherein the oil hole is formed at an acute angle relative to the exterior surface of the at least one bearing.

6. The crankshaft of claim 4, wherein the oil hole is in flow communication with a second oil hole extending from the exterior surface of the other of the at least one bearing.

7. The crankshaft of claim 4, wherein the compressive stress is induced by roller burnishing the first portion of the oil hole.

8. The crankshaft of claim 4, wherein the hardened area is an annular area of the at least one bearing extending radially inwardly from the exterior surface of the at least one bearing.

9. The crankshaft of claim 4, wherein the compressive stress is induced to increase the torsional fatigue strength of the crankshaft.

10. The crankshaft of claim 4, wherein the at least one bearing is formed from cast iron.

11. A method for processing a crankshaft to improve the torsional fatigue strength of the crankshaft, including the steps of:
hardening an outer annular area of a bearing of the crankshaft;
forming an oil hole having an interior bore that extends through the area, the interior bore having a first diameter;
inducing compressive stress in a length of the interior bore of the oil hole, thereby enlarging the first diameter along the length to a diameter that is larger than the first diameter, the length extending through the annular area but not to a terminating end of the oil hole.

12. The method of claim 11, further including the step of chamfering an opening of the oil hole.

13. The method of claim 11, wherein the forming step includes drilling through the annular area at an acute angle relative to a longitudinal axis of the crankshaft to form the oil hole.

14. The crankshaft of claim 11, wherein the oil hole is in flow communication with a second oil hole having an opening at a second bearing of the crankshaft.

15. The crankshaft of claim 11, wherein the compressive stress is induced by roller burnishing the length of the interior bore.

16. The crankshaft of claim 11, wherein the compressive stress is induced to increase the torsional fatigue strength of the crankshaft.

17. The crankshaft of claim 11, wherein the bearing is formed from cast iron.
